(19) United States
(12) Patent Application Publication
(10) Pub. No.: US 2019/0018273 A1
(43) Pub. Date: Jan. 17, 2019

(54) DISPLAY DEVICE

(71) Applicant: Samsung Display Co., Ltd., Yongin-si (KR)

(72) Inventors: Sae Ron Park, Gimhae-si (KR); Jin Suek Kim, Daejeon (KR); Hyun Soo Ryu, Daejeon (KR); Se Joon Oh, Suwon-si (KR); Sang Hun Lee, Suwon-si (KR)

(21) Appl. No.: 16/013,602

(22) Filed: Jun. 20, 2018

(30) Foreign Application Priority Data
Jul. 11, 2017 (KR) 10-2017-0087788

(51) Int. Cl. G02F 1/1339; G02F 1/1368; G02F 1/1335; C09B 1/00; C09B 57/00; C09B 29/20; C09B 29/52; C09B 33/16

(52) U.S. Cl. CPC G02F 1/13394; G02F 2202/36; G02F 1/133621; G02F 1/133514; G02F 1/133528; C09B 1/005; C09B 57/004; C09B 29/20; C09B 29/3673; C09B 57/00; C09B 33/16; G02F 2001/13398; G02F 2001/133614; G02F 2001/13396; G02F 1/1368

(57) ABSTRACT

A display device includes: a light unit for emitting blue light; a color conversion panel on the light unit; a display panel between the light unit and the color conversion panel, the display panel comprising transistors; and column spacers between the transistors and the color conversion panel, the column spacers overlapping the transistors. The color conversion panel includes: a substrate; color conversion layers between the substrate and the display panel, the color conversion layers comprising semiconductor nanocrystals; a transmission layer between the substrate and the display panel; and polarization layers between the color conversion layers and the display panel and between the transmission layer and the display panel. The column spacers include a pigment that absorbs blue light.

### CROSS-REFERENCE TO RELATED APPLICATION

This application claims priority to and the benefit of Korean Patent Application No. 10-2017-0087788, filed in the Korean Intellectual Property Office on Jul. 11, 2017, the entire content of which is incorporated herein by reference.

### BACKGROUND

### 1. Field

The present disclosure relates to a display device.

### 2. Description of the Related Art

A liquid crystal display utilized as a display device may include two electric field generating electrodes, a liquid crystal layer, a color filter, and a polarization layer. Light loss may occur in the polarization layer and the color filter of the display device. Thus, a display device that includes a color conversion display panel for implementation of high color reproducibility while reducing light loss has been suggested.

The above information disclosed in this Background section is only for enhancement of understanding of the background of the invention and therefore it may contain information that does not form prior art.

### SUMMARY

An aspect according to one or more embodiments of the present disclosure is directed toward a display device in which performance deterioration of a transistor due to blue light is prevented or reduced.

A display device according to an exemplary embodiment includes: a light unit for emitting blue light; a color conversion panel on the light unit; a display panel between the light unit and the color conversion panel, and including transistors; and column spacers between the transistors and the color conversion panel, and overlapping the transistors. The color conversion panel includes: a substrate; color conversion layers between the substrate and the display panel and including semiconductor nanocrystals; a transmission layer between the substrate and the display panel; and polarization layers between the color conversion layers and the display panel and between the transmission layer and the display panel. The column spacers include a pigment that absorbs blue light.

The pigment may include at least one of a red pigment, an orange pigment, or a yellow pigment.

The pigment may be included in an amount of about 5 wt % to about 30 wt % with respect to a total amount of the column spacer.

The pigment may include at least one of compounds represented by Chemical Formula 1 to Chemical Formula 8:

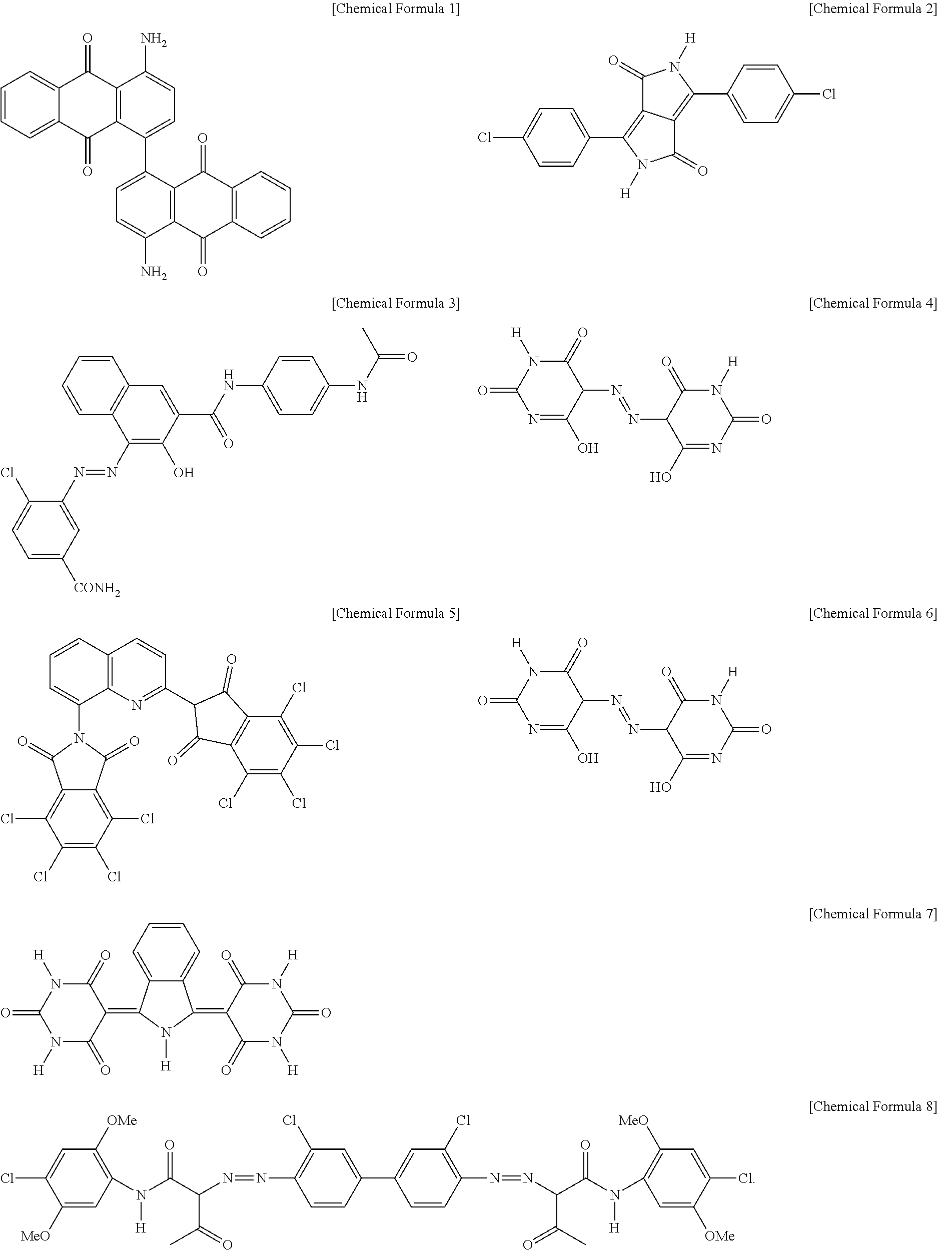

A height of the column spacers may be about 2 μm to about 3.5 μm, and a diameter of the column spacers facing toward the transistors may be about 30 μm to about 40 μm.

An optical density of the column spacers may be about 0.5 to about 1.5.

The light unit may include a blue light emitting diode and the blue light emitting diode may emit light having a wavelength of about 420 nm to about 480 nm.

The polarization layers may include a metallic material.

The column spacers may include a main column spacer and a sub-column spacer, and a height of the main column spacer may be higher than a height of the sub-column spacer.

A display device according to an exemplary embodiment includes: a light unit; a color conversion panel on the light unit; a display panel between the light unit and the color conversion panel, and including transistors; and column spacers between the transistors and the color conversion panel, and overlapping the transistors. The color conversion panel includes: a substrate; color conversion layers between the substrate and the display panel and including semiconductor nanocrystals; a transmission layer between the substrate and the display panel; and polarization layers between the color conversion layers and the display panel and between the transmission layer and the display panel. The light unit emits light having a first wavelength of about 400 nm to about 500 nm, and the column spacers absorb light having the first wavelength.

The column spacers may include a pigment that absorbs light having the first wavelength.

According to exemplary embodiments, performance deterioration of the transistor due to blue light can be prevented or reduced.

### BRIEF DESCRIPTION OF THE DRAWINGS

FIG. 1 is a top plan view of a display area including a plurality of pixels according to an exemplary embodiment of the present invention.

FIG. 2 is a cross-sectional view of the display area shown in FIG. 1, taken along the line II-II′ according to one embodiment of the present invention.

FIG. 3 is a cross-sectional view of the display area shown in FIG. 1, taken along the line III-III′.

FIG. 4 is a cross-sectional view of the display area shown in FIG. 1, taken along the line IV-IV′.

FIG. 5 is a cross-sectional view of the display area shown in FIG. 1, taken along the line II-II′ according to another embodiment of the present invention.

### DETAILED DESCRIPTION

Hereinafter, exemplary embodiments of the present invention will be described in more detail with reference to the accompanying drawings. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

In addition, the size and thickness of each configuration shown in the drawings are arbitrarily shown for better understanding and ease of description, but the present invention is not limited thereto. In the drawings, the thicknesses of layers, films, panels, regions, etc., are exaggerated for clarity.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” refers to the situation where one element is positioned on or below the object portion, and does not necessarily mean one element is positioned on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

In this specification, the phrase “on a plane” refers to the viewing of a target portion from the top, and the phrase “on a cross-section” refers to the viewing of a cross-section formed by vertically cutting a target portion from the side.

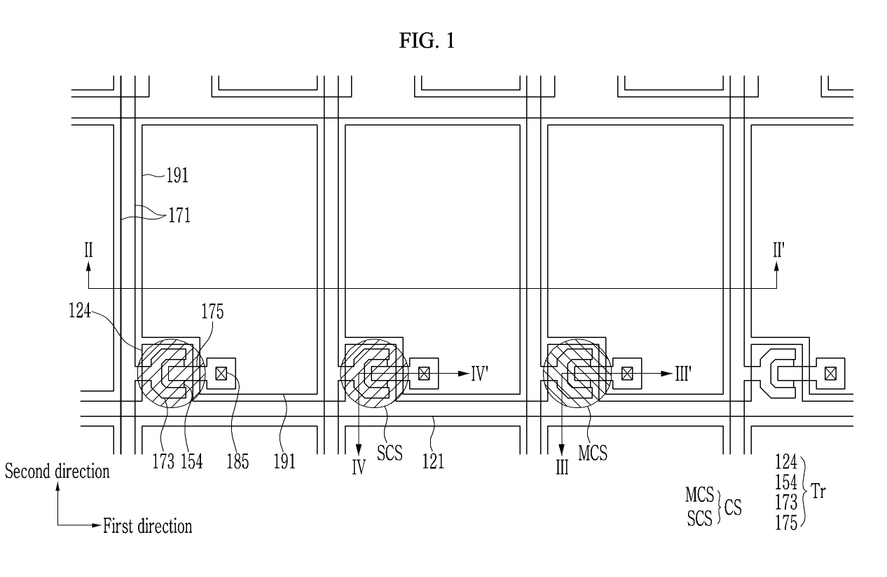

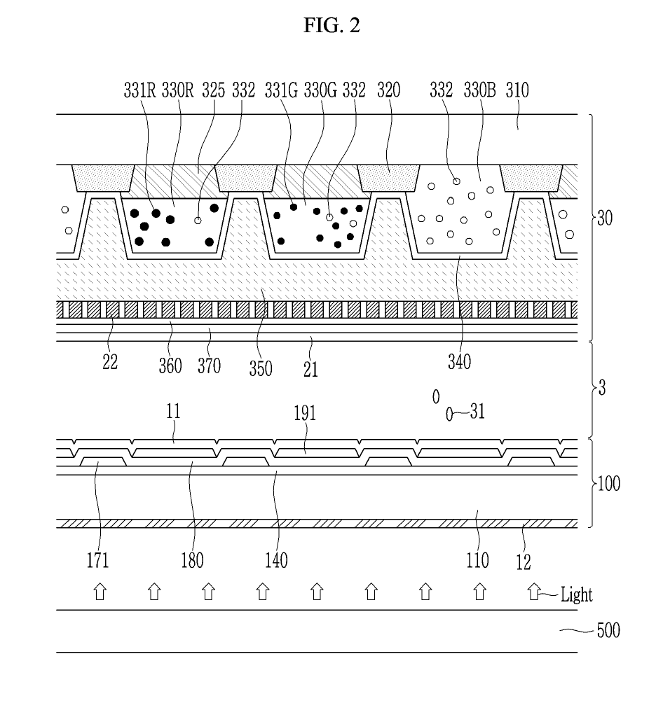

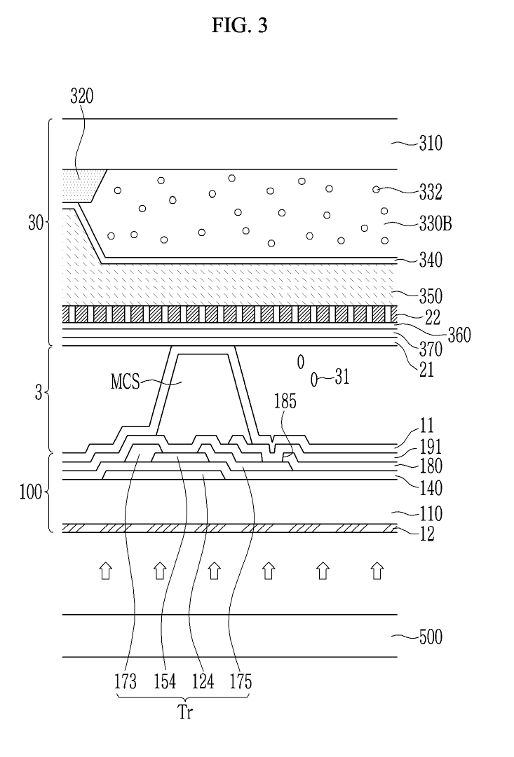

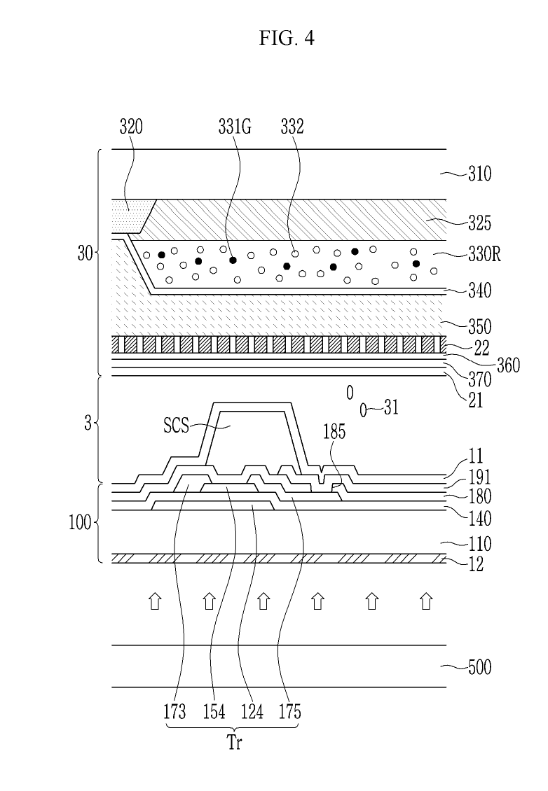

Hereinafter, a display device according to an exemplary embodiment will be described with reference to FIG. 1 to FIG. 4. FIG. 1 is a top plan view of a display area including a plurality of pixels according to an exemplary embodiment of the present invention, FIG. 2 is a cross-sectional view of the display area shown in FIG. 1, taken along the line II-II′; FIG. 3 is a cross-sectional view of the display area shown in FIG. 1, taken along the line III-III′; and FIG. 4 is a cross-sectional view of the display area shown in FIG. 1, taken along the line IV-IV′.

The display device according to the exemplary embodiment includes a light unit 500, a display panel 100, a color conversion panel 30, and a liquid crystal layer 3.

The light unit 500 may include a light source for generating light having a first wavelength, and a light guide that receives the light generated from the light source and guides the light in a direction where the display panel 100 and the color conversion panel 30 are disposed. The first wavelength may be about 400 nm to about 500 nm, and may be about 420 nm to about 480 nm in an exemplary embodiment. The light source may emit blue light, and for example, may be provided as a blue light emitting diode.

Instead of the light unit 500 including the blue light source, a light unit 500 including a white light source or an ultraviolet (UV) light source may be utilized. However, hereinafter, a display device including the light unit 500 including the blue light source will be described.

The display panel 100 and the color conversion panel 30 overlap each other, and the liquid crystal layer 3 including a plurality of liquid crystal molecules 31 is disposed between the two panels (i.e., the display panel 100 and the color conversion panel 30).

The display device according to the present exemplary embodiment may include a first polarization layer 12 that is disposed between a first substrate 110 and the light unit 500. The first polarization layer 12 may linearly polarize light generated from the light unit 500.

As the first polarization layer 12, a coating polarization layer (e.g., a coated polarization layer), a film polarization layer, or a wire grid polarizer may be utilized. The first polarization layer 12 may be provided on one side of the first substrate 110 in various suitable forms (such as being attached in a film form, formed in a spread form (e.g., formed on the substrate 110 through coating), or formed through printing). However, the present invention is not limited thereto.

The display panel 100 is disposed on the first substrate 110, and includes gate lines 121 that extend in the first direction, a gate electrode 124, a gate insulation layer 140 disposed on the gate lines 121, and a semiconductor layer 154 disposed on the gate insulation layer 140. Next, data lines 171 extending in the second direction on the gate insulation layer 140 and connected with a source electrode 173 are disposed on the gate insulation layer 140, a drain electrode 175 is disposed on the same layer as the source electrode 173, and a passivation layer 180 is disposed on the data lines 171 and the drain electrode 175.

The semiconductor layer 154 disposed on the gate electrode 124 includes a channel layer disposed between the source electrode 173 and the drain electrode 175. The gate electrode 124, the semiconductor layer 154, the source electrode 173, and the drain electrode 175 form one transistor Tr.

Pixel electrodes 191 are disposed on the passivation layer 180. Each pixel electrode 191 is electrically connected with the drain electrode 175 through a contact hole 185 of the passivation layer 180.

The pixel electrodes 191 are arranged in a matrix format, and the shape of the pixel electrode 191 can be variously modified. In the present specification, the pixel electrode 191 is illustrated as a planar pixel electrode 191, but the pixel electrode 191 may have the shape of a slit in an exemplary embodiment.

A column spacer CS and a first alignment layer 11 may be disposed on the pixel electrode 191.

The column spacer CS may include a pigment that absorbs blue light. The column spacer CS may absorb light having the first wavelength of about 400 nm to about 500 nm. The first wavelength may be, for example, 420 nm to 480 nm.

The pigment may include at least one of a red pigment, an orange pigment, or a yellow pigment. For example, the pigment may include at least one of the compounds represented by Chemical Formula 1 to Chemical Formula 8.

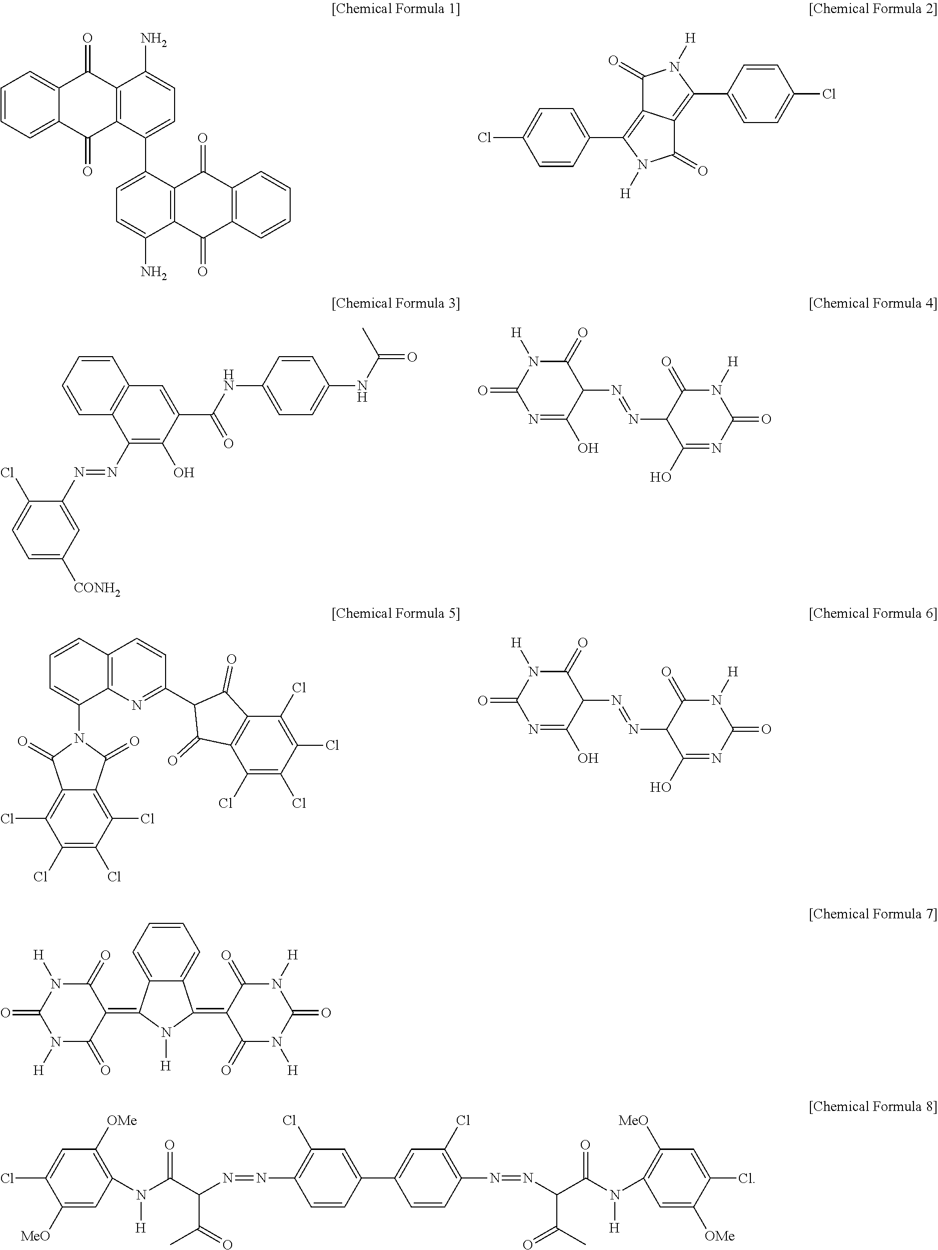

In addition, in the present specification, the pigment that absorbs blue light is described, but the present invention is not limited thereto. Depending on an exemplary embodiment, a pigment that absorbs red light or a pigment that absorbs green light may be included. This is for prevention of color mixing between adjacent pixels, and for example, a compound represented by Chemical Formula 9 or a compound represented by Chemical Formula 10 may be included.

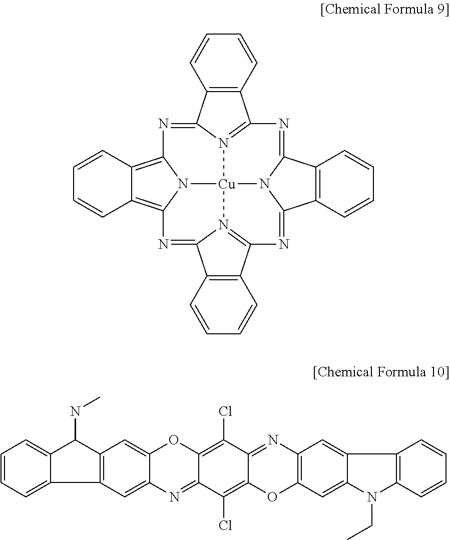

The pigment may be included with a content (i.e., amount or weight) of about 5 wt % to about 30 wt % with respect to the entire content (i.e., amount or weight) of the column spacer CS. When the amount of pigment is less than 5 wt %, blue light cannot be effectively absorbed, and when the amount of pigment exceeds 30 wt %, reliability of a manufacturing process of the column spacer CS may be deteriorated. When the pigment is excessively included, an etching process for forming the column spacer may not be precisely performed.

A related art column spacer may be made of a transparent material, but the column spacer CS according to the exemplary embodiment includes the pigment so that deterioration of a feature of the transistor Tr can be prevented or reduced by absorbing blue light emitted toward the transistor Tr while maintaining a gap for the liquid crystal layer 3.

The column spacer CS may include a main column spacer MCS and a sub-column spacer SCS. In the present specification, the main column spacer MCS overlaps an area that emits blue light and the sub-column spacer SCS overlaps areas that respectively emit green light and red light, but the present invention is not limited thereto. The main column spacer MCS may overlap the areas emitting green light and red light.

A height of the column spacer CS may be about 2 μm to 3.5 μm, and a diameter of the bottom side of the column spacer CS facing toward the transistor Tr may be about 30 μm to about 40 μm. A height of the main column spacer MCS may be about 2.5 μm to 3.5 μm, and a height of the sub-column spacer SCS may be about 2 μm to 3 μm. The height and the size of the column spacer CS are not limited to the above-stated description, and the column spacer CS may have a height suitable for maintaining a gap for the liquid crystal layer 3 and a size suitable for covering the transistor Tr.

The column spacer CS may have an optical density OD of about 0.5 to about 1.5. The optical density OD may be represented as given in Equation 1. In Equation 1, T denotes transmittance when light having a wavelength of about 450 nm is transmitted through a material having a thickness of about 1 μm.

$$OD = {log}_{10} \frac{1}{T} \qquad [ Equation 1 ]$$

The column spacer CS prevents or reduces the deterioration of performance of the transistor Tr due to blue light, which is reflected by a second polarization layer 22 and incident on the channel layer of the transistor Tr. A part of blue light emitted from the light unit 500 may be reflected by the second polarization layer 22 that is made of a metallic material, and a part of the reflected light may be incident on the transistor Tr. The incident blue light affects the channel layer so that a leakage current of the transistor Tr may be increased. However, when the column spacer CS of the present exemplary embodiment is included, the column spacer CS absorbs the blue light that would otherwise be incident on the channel layer so that the leakage current of the transistor Tr can be prevented from increasing and reliability of the display device can be improved.

The color conversion panel 30 includes a second substrate 310 that is disposed apart from the first substrate 110 while overlapping the first substrate 110. A light blocking member 320 may be disposed between the second substrate 310 and the display panel 100.

The light blocking member 320 is disposed between a first color conversion layer 330R and a second color conversion layer 330G that are adjacent to each other, between the second color conversion layer 330G and a transmission layer 330B that are adjacent to each other, and between the transmission layer 330B and a first color conversion layer 330R that are adjacent to each other, and may partition areas where the first color conversion layer 330R, the second color conversion layer 330G, and the transmission layer 330B are formed.

The light blocking member 320 may include a material that absorbs incident light or a material that reflects light. For example, the light blocking member 320 including a metal material reflects light incident on the light blocking member 320 from the first color conversion layer 330R, the second color conversion layer 330G, and the transmission layer 330B back to the first color conversion layer 330R, the second color conversion layer 330G, and the transmission layer 330B, thereby improving light efficiency.

A blue light cutting filter 325 may be disposed between the second substrate 310 and the first color conversion layer 330R and between the second substrate 310 and the second color conversion layer 330G. The blue light cutting filter 325 is disposed only in the areas where red light and green light are emitted and is not disposed in the area where blue light is emitted.

As shown in FIG. 2, the blue light cutting filters 325 may be disposed apart from each other between the area that overlaps the first color conversion layer 330R and the area that overlaps the second color conversion layer 330G, but the present invention is not limited thereto. The blue light cutting filter 325 disposed in the area overlapping the first color conversion layer 330R and the blue light cutting filter 325 disposed in the area overlapping the second color conversion layer 330G may be connected with each other.

The blue light cutting filter 325 may block or absorb blue light supplied from the light unit 500. Light incident from the light unit 500 is converted into red light or green light by semiconductor nanocrystals (e.g., included in the first color conversion layer 330R and the second color conversion layer 330G), and in this case, a portion of the blue light may be emitted to the outside through the second substrate 310 without being converted (e.g., changed). The blue light cutting filter 325 is provided with a structure of a single layer or multiple layers to prevent or reduce such a problem of the blue light.

The blue light cutting filter 325 may include any suitable material that can carry out the above-stated effect, and for example, may be provided as a yellow color filter.

The first color conversion layer 330R and the second color conversion layer 330G may be respectively disposed between the blue light cutting filter 325 and the display panel 100, and the transmission layer 330B may be provided between the second substrate 310 and the display panel 100.

The first color conversion layer 330R includes first semiconductor nanocrystals 331R, and the second color conversion layer 330G may include second semiconductor nanocrystals 331G. Light (e.g., predetermined light) incident on the first color conversion layer 330R may be converted into red light by the first semiconductor nanocrystals 331R and then emitted from the first color conversion layer 330R. Light (e.g., predetermined light) incident on the second color conversion layer 330G may be converted into green light by the second semiconductor nanocrystals 331G and then emitted from the second color conversion layer 330G.

The first semiconductor nanocrystals 331R include at least one of a phosphor that converts incident blue light into red light, or a quantum dot. The second semiconductor nanocrystals 331G include at least one of a phosphor that converts incident blue light into green light, or a quantum dot.

The quantum dot may be selected from a group II-VI compound, a group III-V compound, a group IV-VI compound, a group IV element, a group IV compound, and a combination thereof.

The group II-VI compound may be selected from a two-element compound selected from CdSe, CdTe, ZnS, ZnSe, ZnTe, ZnO, HgS, HgSe, HgTe, MgSe, MgS, and a mixture thereof; a three-element compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a mixture thereof; and a four-element compound selected from HgZnTeS, CdZnSeS, CdZnSeTe, CdZnSTe, CdHgSeS, CdHgSeTe, CdHgSTe, HgZnSeS, HgZnSeTe, HgZnSTe, and a mixture thereof. The group III-V compound may be selected from a two-element compound selected from GaN, GaP, GaAs, GaSb, AlN, AlP, AlAs, AlSb, InN, InP, InAs, InSb, and a mixture thereof; a three-element compound selected from GaNP, GaNAs, GaNSb, GaPAs, GaPSb, AlNP, AlNAs, AlNSb, AlPAs, AlPSb, InNP, InNAs, InNSb, InPAs, InPSb, and a mixture thereof; and a four-element compound selected from GaAlNAs, GaAlNSb, GaAlPAs, GaAlPSb, GaInNP, GaInNAs, GaInNSb, GaInPAs, GaInPSb, GaAlNP, InAlNP, InAlNAs, InAlNSb, InAlPAs, InAlPSb, and a mixture thereof. The group IV-VI compound may be selected from a two-element compound selected from SnS, SnSe, SnTe, PbS, PbSe, PbTe, and a mixture thereof; a three-element compound selected from SnSeS, SnSeTe, SnSTe, PbSeS, PbSeTe, PbSTe, SnPbS, SnPbSe, SnPbTe, and a mixture thereof; and a four-element compound selected from SnPbSSe, SnPbSeTe, SnPbSTe, and a mixture thereof. The group IV element may be selected from Si, Ge, and a mixture thereof. The group IV compound may be a two-element compound selected from SiC, SiGe, and a mixture thereof.

In this case, the two-element compound, the three-element compound, or the four-element compound may exist in particles with uniform concentration (e.g., the elements for forming these compounds are uniformly distributed throughout the particles), or may exist in the same particle with partially different concentration dispersion (e.g., the elements for forming these compounds are not uniformly distributed throughout the particles). In addition, the quantum dot may have a core/shell structure in which one quantum dot encloses another quantum dot. An interface (i.e., interfacing surface) between the core and the shell may have a concentration gradient in which the concentration of an element decreases when it is closer to the center of the quantum dot.

The quantum dot may have a full width at half maximum (FWHM) of a light emission wavelength spectrum of about 45 nm or less, for example, about 40 nm or less, or about 30 nm or less. When the FWHM of the quantum dot is within the above described ranges, color purity or color reproducibility can be improved. In addition, light emitted through such a quantum dot is omnidirectionally emitted (e.g., emitted uniformly in all directions) so that a wide viewing angle can be improved.

In addition, shapes of the quantum dot are not specifically limited to shapes that are generally utilized in the related art. For example, it is desirable that a nanoparticle having a spherical, pyramidal, multi-arm, or cubic shape, or a nanotube, a nanowire, a nanofiber, or a planar nanoparticle, is utilized.

A phosphor emitting red light may be one of (Ca, Sr, Ba)S, (Ca, Sr, Ba)₂Si₅N₈, CaAlSiN₃, CaMoO₄, or Eu₂Si₅N₈, but the present invention is not limited thereto.

A phosphor emitting green light may be one of yttrium aluminum garnet

(YAG), (Ca, Sr, Ba)₂SiO₄, SrGa₂S₄, barium magnesium (BAM), alpha SiAlON (α-SiAlON), beta SiAlON (β-SiAlON), Ca₃Sc₂Si₃O₁₂, Tb₃Al₅O₁₂, BaSiO₄, CaAlSiON, or (Sr₁₀ₓBax)Si₂O₂N₂, but the present invention is not limited thereto. The second color conversion layer 330G may include at least one green phosphor. In this case, the x in (Sr₁₋ₓBax)Si₂O₂N₂ may be a number between 0 and 1.

The transmission layer 330B may transmit incident light. The transmission layer 330B may transmit blue light. The transmission layer 330B may be (e.g., may include) a polymer material that transmits blue light supplied from the light unit 500. The transmission layer 330B corresponding to the area where the blue light is emitted does not include separate semiconductor nanocrystals and thus incident blue light is directly transmitted.

At least one of the first color conversion layer 330R, the second color conversion layer 330G, or the transmission layer 330B may include a scatterer 332. The scatterer 332 may scatter light incident on the first color conversion layer 330R, the second color conversion layer 330G, and the transmission layer 330B, or may make front luminance and side luminance uniform. The scatterer 332 may include, for example, at least one selected from TiO₂, Al₂O₃, or SiO₂, but the present invention is not limited thereto.

The transmission layer 330B may further include at least one of a blue pigment or a dye. The blue pigment and the dye can absorb at least one of red light or green light included in external light so that deterioration of color reproducibility due to reflection of external light can be prevented or reduced.

A light filter layer 340 may be disposed between the first color conversion layer 330R, the second color conversion layer 330G, and the transmission layer 330B, and the liquid crystal layer 3.

The light filter layer 340 may enhance light efficiency by reflecting light generated from the first color conversion layer 330R and the second color conversion layer 330G.

The light filter layer 340 may include a plurality of layers, and the plurality of layers may have a structure in which different layers are alternately arranged along a direction that is substantially perpendicular to the second substrate 310. The light filter layer 340 formed by alternately arranging layers having different refractive indexes may have a structure of about 10 to 20 layers, but the present invention is not limited thereto.

The light filter layer 340 may have, for example, a structure in which a silicon oxide (SiOx) layer and a silicon nitride (SiNy) layer are alternately arranged, but the present invention is not limited thereto. Further, as an exemplary material having a relatively high refractive index, titanium oxide, tantalum oxide, hafnium oxide, or zirconium oxide may be utilized, and as an exemplary material having a relatively low refractive index, SiCOz or the like may be utilized. In SiOx, SiNy, and SiCOz, x, y, and z are factors that determine a chemical composition ratio, and may be adjusted according to a film forming process condition.

When a layer that is the closest to the first color conversion layer 330R, the second color conversion layer 330G, and the transmission layer 330B among the plurality of layers that form the light filter layer 340 is formed as a silicon nitride layer, the silicon nitride layer may serve as a passivation layer. That is, the silicon nitride layer can prevent or substantially prevent the first color conversion layer 330R, the second color conversion layer 330G, and the transmission layer 330B from being damaged due to processes performed after the first color conversion layer 330R, the second color conversion layer 330G, and the transmission layer 330B are formed. The semiconductor nanocrystals included in the first color conversion layer 330R and the second color conversion layer 330G may be damaged or light-quenched due to moisture or high-temperature processes, and the silicon nitride layer can prevent or substantially prevent such a problem.

A planarization layer 350 is disposed between the light filter layer 340 and the liquid crystal layer 3. The planarization layer 350 may planarize one side of a constituent element disposed between the planarization layer 350 and the second substrate 310.

A second polarization layer 22 may be disposed between the planarization layer 350 and the liquid crystal layer 3. The second polarization layer 22 polarizes light passed through the light unit 500, the display panel 100, and the liquid crystal layer 3.

The second polarization layer 22 may be coating-type polarization layer (e.g., a coated polarization layer), a film-type polarization layer, a wire grid polarizer, and/or the like. The second polarization layer 22 may include a metallic material. The second polarization layer 22 includes a plurality of nano-patterns according to exemplary embodiments, and a width of each nano-pattern may be a few nanometers.

Because the second polarization layer 22 includes the metallic material, blue light emitted from the light unit 500 may be reflected back toward the display panel 100 by the second polarization layer 22. Some of the reflected light may be incident in a direction of the transistor. However, the display panel 100 according to the exemplary embodiment of the present invention includes the column spacers that cover (e.g., overlap with) the transistors, and therefore blue light reflected in the direction of the transistor Tr can be absorbed. Thus, a problem of a current leakage due to influence of the blue light on the channel layer and the like can be prevented or substantially prevented, thereby providing a display device having improved reliability.

An insulation layer 360, a common electrode 370, and a second alignment layer 21 may be sequentially disposed between the second polarization layer 22 and the liquid crystal layer 3.

The insulation layer 360 may insulate the second polarization layer 22, which is made of a metallic material, and the common electrode 370 from each other. If the second polarization layer 22 is not made of a metallic material, the insulation layer 360 may be omitted (e.g., may not be included).

The common electrode 370 applied with a common voltage may form an electric field with the pixel electrode 191. As an exemplary variation, the common electrode 370 may be disposed in the display panel 100.

The second alignment layer 21 may include substantially the same material as the first alignment layer 11, and may be manufactured through substantially the same method as the first alignment layer 11.

Because the above-described display device includes the light unit 500 providing blue light and the color conversion layers 330R and 330G emitting red light and green light, light having improved color purity can be provided. In addition, the second polarization layer 22 included in the color conversion panel 30 has a thickness of several nanometers, and accordingly, a light path is short, thereby minimizing distortion of light. Further, blue light that is reflected by the second polarization layer 22 and is thus incident on the transistor Tr is absorbed by the column spacer CS covering the transistor Tr so that performance deterioration of the transistor Tr can be prevented or reduced.

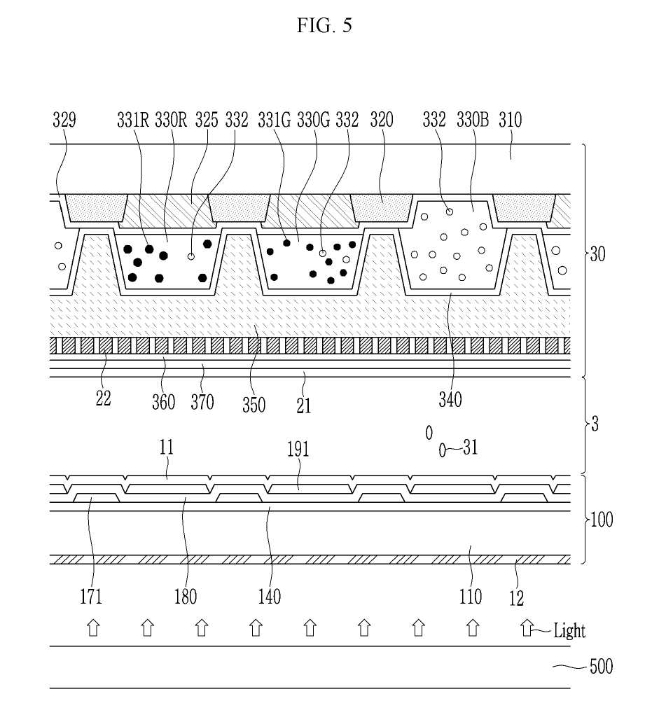

Hereinafter, an exemplary variation of the present invention will be described with reference to FIG. 5. FIG. 5 is a cross-sectional view of an exemplary variation of the exemplary embodiment of FIG. 2.

Referring to FIG. 5, a first auxiliary layer 329 may be disposed between a second substrate 310, a light blocking member 320, and a blue light cutting filter 325 and a first color conversion layer 330R, a second color conversion layer 330G, and a transmission layer 330B. In addition, a light filter layer 340 may be disposed between the first color conversion layer 330R, the second color conversion layer 330G, the transmission layer 330B, and a planarization layer 350. The first auxiliary layer 329 and the light filter layer 340 may include a material having a relatively low refractive index. The material may include, for example, SiNy, SiCOz, and the like.

Constituent elements other than those described above are the same as those of the above-described constituent elements of FIG. 1 to FIG. 4, and therefore the description thereof will not be repeated below.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims, and equivalents thereof.

### DESCRIPTION OF SOME OF THE SYMBOLS

100: display panel
30: color conversion panel
CS: column spacer
330R: first color conversion layer
330G: second color conversion layer
330B: transmission layer

What is claimed is:

1. A display device comprising:
a light unit configured to emit blue light;
a color conversion panel on the light unit;
a display panel between the light unit and the color conversion panel, the display panel comprising transistors; and
column spacers between the transistors and the color conversion panel, the column spacers overlapping the transistors,
wherein the color conversion panel comprises:
a substrate;
color conversion layers between the substrate and the display panel, the color conversion layers comprising semiconductor nanocrystals;
a transmission layer between the substrate and the display panel; and
polarization layers between the color conversion layers and the display panel and between the transmission layer and the display panel, and
wherein the column spacers comprise a pigment that absorbs blue light.

2. The display device of claim 1, wherein the pigment comprises at least one of a red pigment, an orange pigment, or a yellow pigment.

3. The display device of claim 1, wherein the pigment is included in an amount of about 5 wt % to about 30 wt % with respect to a total amount of the column spacers.

4. The display device of claim 2, wherein the pigment comprises at least one of compounds represented by Chemical Formula 1 to Chemical Formula 8:

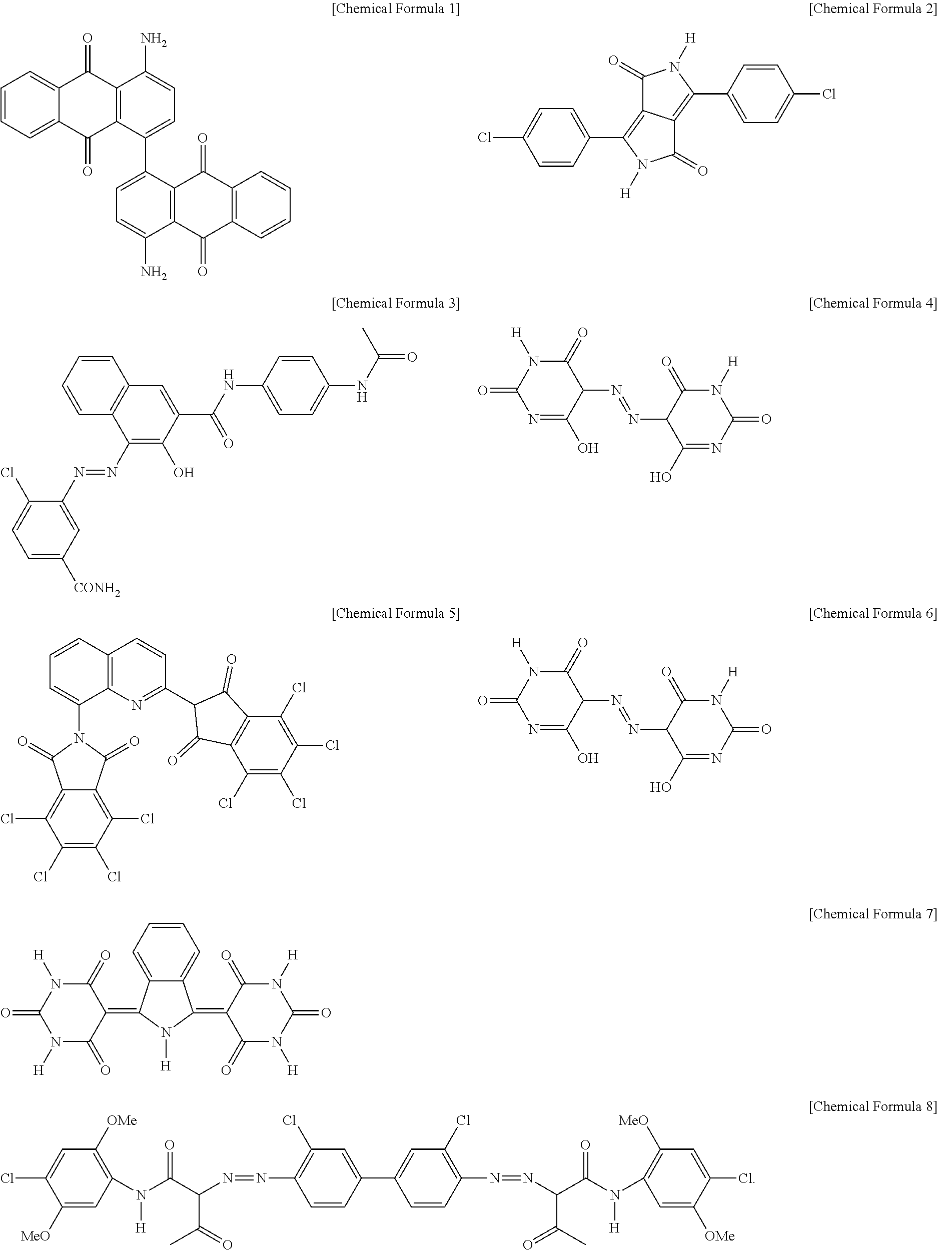

5. The display device of claim 1, wherein a height of the column spacers is about 2 μm to about 3.5 μm, and a diameter of the column spacers facing toward the transistors is about 30 μm to about 40 μm.

6. The display device of claim 1, wherein an optical density of the column spacers is about 0.5 to about 1.5.

7. The display device of claim 1, wherein the light unit comprises a blue light emitting diode configured to emit light having a wavelength of about 420 nm to about 480 nm.

8. The display device of claim 1, wherein the polarization layers comprise a metallic material.

9. The display device of claim 1, wherein the column spacers comprise a main column spacer and a sub-column spacer, and a height of the main column spacer is higher than a height of the sub-column spacer.

10. A display device comprising:
a light unit;
a color conversion panel on the light unit;
a display panel between the light unit and the color conversion panel, the display panel comprising transistors; and
column spacers between the transistors and the color conversion panel, the column spacers overlapping the transistors,
wherein the color conversion panel comprises:
a substrate;
color conversion layers between the substrate and the display panel and including semiconductor nanocrystals;
a transmission layer between the substrate and the display panel; and
polarization layers between the color conversion layers and the display panel and between the transmission layer and the display panel,
wherein the light unit is configured to emit light having a first wavelength of about 400 nm to about 500 nm, and
the column spacers are configured to absorb light having the first wavelength.

11. The display device of claim 10, wherein the column spacers comprise a pigment configured to absorb light having the first wavelength.

12. The display device of claim 11, wherein the pigment comprises at least one of a red pigment, an orange pigment, or a yellow pigment.

13. The display device of claim 11, wherein the pigment is included in an amount of about 5 wt % to about 30 wt % with respect to a total amount of the column spacers.

14. The display device of claim 12, wherein the pigment comprises at least one of compounds represented by Chemical Formula 1 to Chemical Formula 8:

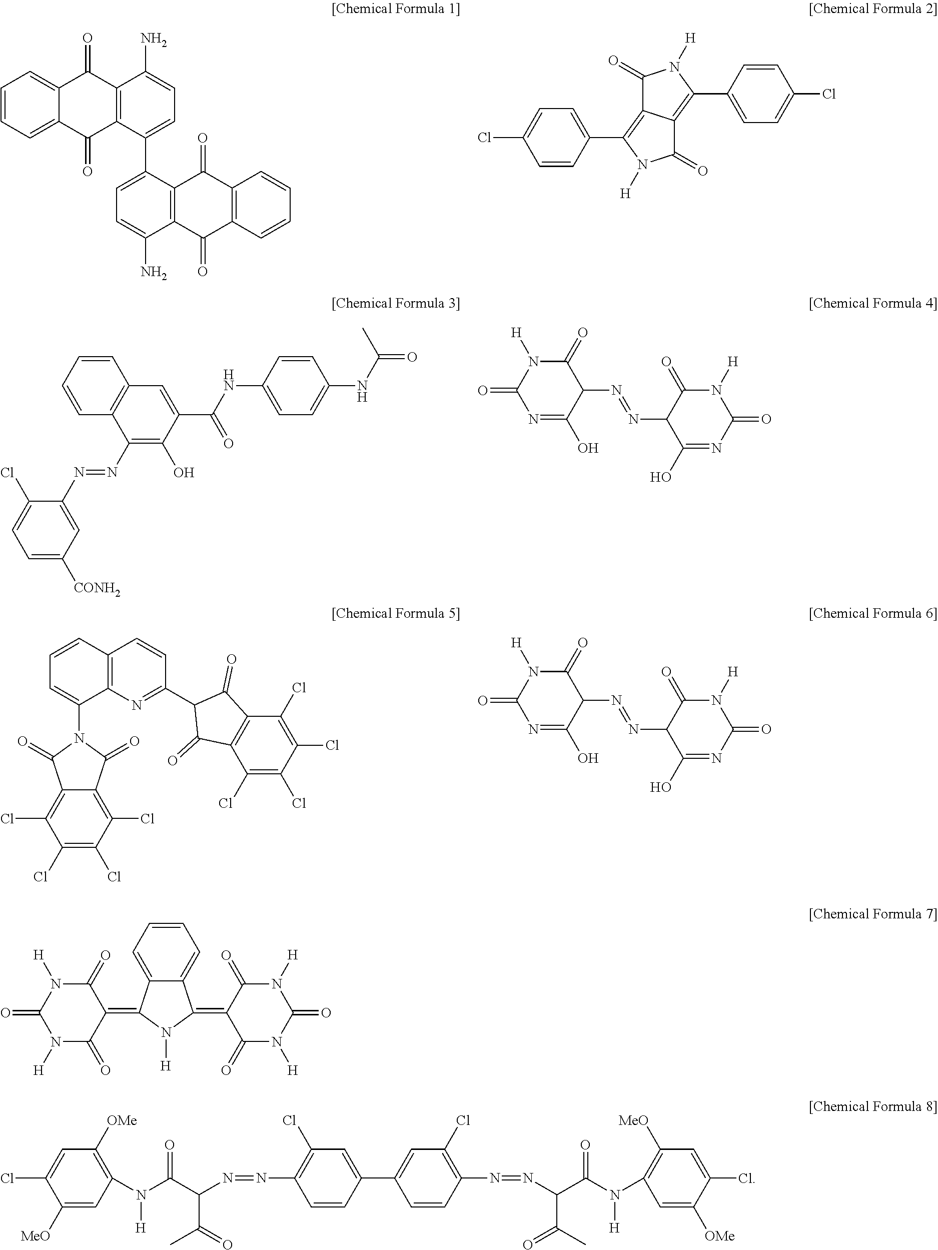

15. The display device of claim 10, wherein a height of the column spacers is about 2 μm to about 3.5 μm, and a diameter of the column spacers facing toward the transistors is about 30 μm to about 40 μm.

16. The display device of claim 10, wherein an optical density of the column spacers is about 0.5 to about 1.5.

17. The display device of claim 10, wherein the light unit comprises a blue light emitting diode configured to emit light having a wavelength of about 420 nm to about 480 nm.

18. The display device of claim 10, wherein the polarization layers comprise a metallic material.

19. The display device of claim 10, wherein the column spacers comprise a main column spacer and a sub-column spacer, and a height of the main column spacer is higher than a height of the sub-column spacer.
